(19) United States
(12) Patent Application Publication
(10) Pub. No.: US 2026/0215367 A1
(43) Pub. Date: Jul. 30, 2026

(54) DIVERTER CONTROL SYSTEM FOR AN AGRICULTURAL HARVESTER REEL ASSEMBLY

(71) Applicant: CNH Industrial America LLC, New Holland, PA (US)

(72) Inventor: Cory Douglas Hunt, Millersville, PA (US)

(21) Appl. No.: 19/037,545

(22) Filed: Jan. 27, 2025

(51) Int. Cl. A01D 57/03

(52) U.S. Cl. CPC A01D 57/03

(57) ABSTRACT

A diverter control system for a reel assembly of an agricultural harvester includes a controller configured to identify potential contact between a tine coupled to a bat tube of the reel assembly and a cutter bar assembly of the agricultural harvester. The controller is also configured to determine whether a distance between a diverter of a diverter system and a follower coupled to the bat tube is greater than a threshold distance. Furthermore, the controller is configured to control an actuator of the diverter system to drive the diverter to an engaged position in response to identifying the potential contact between the tine and the cutter bar assembly and determining the distance between the diverter and the follower is greater than the threshold distance. The diverter is configured to engage the follower to drive the tine to a retracted position while the diverter is in the engaged position.

### BACKGROUND

The present disclosure relates generally to a diverter control system for an agricultural harvester reel assembly.

A harvester may be used to harvest agricultural crops, such as barley, beans, beets, carrots, corn, cotton, flax, oats, potatoes, rye, soybeans, wheat, or other plant crops. Furthermore, a combine (e.g., combine harvester) is a type of harvester generally used to harvest certain crops that include grain (e.g., barley, corn, flax, oats, rye, wheat, etc.). During operation of a combine, the harvesting process may begin by removing agricultural crops from a field, such as by using a header. The header may cut the agricultural crops and transport the cut crops to a processing system of the combine.

Certain headers include a cutter bar assembly configured to cut a portion of each crop (e.g., a stalk), thereby separating the cut crop from the soil. The cutter bar assembly may extend along a substantial portion of the width of the header at a forward end of the header, and the cutter bar assembly may be flexible along the width of the header. The header may also include an auger positioned behind the cutter bar assembly relative to the direction of travel of the harvester. The auger is configured to transport the cut crops to an inlet of the processing system. Certain headers include a reel assembly configured to direct the crops cut by the cutter bar assembly toward the auger, thereby substantially reducing the possibility of the cut crops falling onto the surface of the field.

Certain reel assemblies include a reel having a rotating structure, multiple bat tubes rotatably coupled to the rotating structure, and multiple tines coupled to each bat tube. The rotating structure is driven to rotate such that the bat tubes move in a circular pattern, and a tine rotation mechanism is configured to drive the bat tubes to rotate relative to the rotating structure. The tines are configured to engage the cut crops and to urge the cut crops to move toward the auger. The reel is typically supported by multiple arms extending from a frame of the header.

### BRIEF DESCRIPTION

In certain embodiments, a diverter control system for a reel assembly of an agricultural harvester includes a controller having a memory and a processor. The controller is configured to identify potential contact between a tine coupled to a bat tube of the reel assembly and a cutter bar assembly of the agricultural harvester. The controller is also configured to determine whether a distance between a diverter of a diverter system and a follower coupled to the bat tube along a path of the follower is greater than a threshold distance. Furthermore, the controller is configured to control an actuator of the diverter system to drive the diverter to an engaged position in response to identifying the potential contact between the tine and the cutter bar assembly and determining the distance between the diverter and the follower is greater than the threshold distance. The diverter is configured to engage the follower to drive the tine to a retracted position while the diverter is in the engaged position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header;

FIG. 2 is a perspective view of an embodiment of a header that may be employed within the agricultural harvester of FIG. 1;

FIG. 3 is a perspective view of a portion of an embodiment of a reel assembly that may be employed within the header of FIG. 2, in which the reel assembly includes a diverter system;

FIG. 4 is a side view of the reel assembly of FIG. 3, in which a diverter of the diverter system is in a disengaged position;

FIG. 5 is a side view of the reel assembly of FIG. 3, in which the diverter of the diverter system is in an engaged position;

FIG. 6 is a side view of an embodiment of a diverter system that may be employed within the reel assembly of FIG. 3;

FIG. 7A is a side view of an embodiment of a latch assembly that may be employed within the reel assembly of FIG. 3, in which the latch assembly is in a latched state;

FIG. 7B is a side view of the latch assembly of FIG. 7A, in which the latch assembly is in an unlatched state; and

FIG. 8 is a block diagram of an embodiment of a diverter control system that may be employed within the diverter system of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

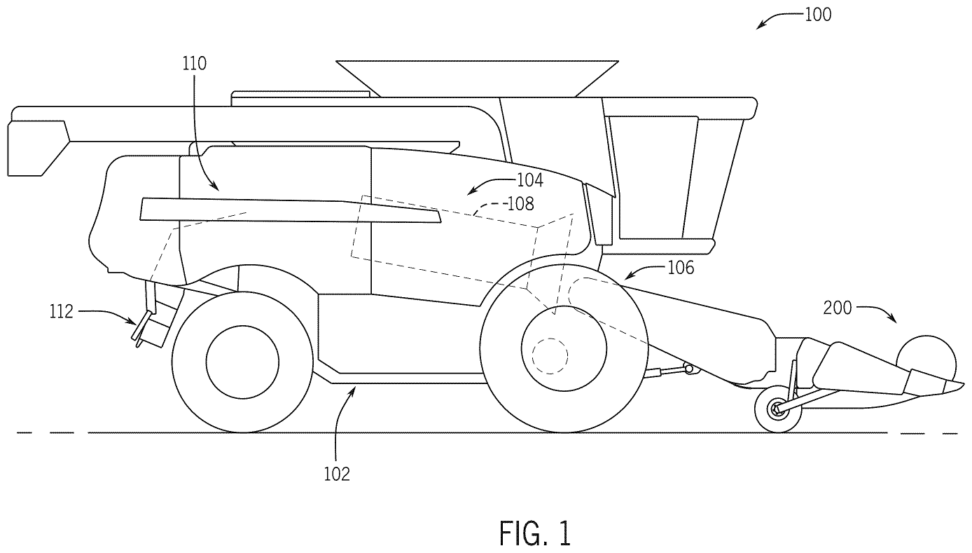

FIG. 1 is a side view of an embodiment of an agricultural harvester 100 having a header 200 (e.g., agricultural header). The agricultural harvester 100 includes a chassis 102 configured to support the header 200 and an agricultural crop processing system 104. As described in greater detail below, the header 200 is configured to cut crops and to transport the cut crops toward an inlet 106 of the agricultural crop processing system 104 for further processing of the cut crops. The agricultural crop processing system 104 receives cut crops from the header 200 and separates desired crop material from crop residue. For example, the agricultural crop processing system 104 may include a thresher 108 having a cylindrical threshing rotor that transports the crops in a helical flow path through the harvester 100. In addition to transporting the crops, the thresher 108 may separate certain desired crop material (e.g., grain) from the crop residue, such as husks and pods, and enable the desired crop material to flow into a cleaning system located beneath the thresher 108. The cleaning system may remove debris from the desired crop material and transport the desired crop material to a storage compartment within the harvester 100. The crop residue may be transported from the thresher 108 to a crop residue handling system 110, which may remove the crop residue from the harvester 100 via a crop residue spreading system 112 positioned at the aft end of the harvester 100.

As discussed in detail below, the header 200 includes a cutter bar assembly configured to cut the crops within the field. The header 200 also includes a reel assembly configured to urge crops cut by the cutter bar assembly to an auger that conveys the cut crops toward the inlet 106 of the agricultural crop processing system 104. As discussed in detail below, the reel assembly includes a reel having a rotating structure configured to be driven in rotation. The reel also includes multiple bat tubes rotatably coupled to the rotating structure. Furthermore, the reel includes multiple tines coupled to each bat tube. A tine rotation mechanism (e.g., a cam and follower assembly or a parallel state assembly) is configured to drive the bat tubes to rotate in response to rotation of the rotating structure. Accordingly, the tines rotate in a first pattern (e.g., circular pattern) about a rotational axis of the rotating structure and in second patterns (e.g., circular patterns or oscillating patterns) about rotational axes of respective bat tubes. The tines are configured to engage the cut crops and to urge the cut crops to move toward the auger.

As discussed in detail below, the reel assembly of the header 200 includes a diverter system configured to substantially reduce or eliminate the possibility of contact between the tines of the reel assembly and the cutter bar assembly. The diverter system includes a diverter configured to move between an engaged position and a disengaged position. While the diverter is in the engaged position, the diverter is configured to engage a follower coupled to each bat tube to drive the tines coupled to the bat tube to a retracted position. With the tines in the retracted position, the possibility of the tines contacting the cutter bar assembly is substantially reduced or eliminated. The diverter system also includes an actuator configured to drive the diverter to move from the disengaged position to the engaged position. In addition, the diverter system includes a diverter control system having a controller communicatively coupled to the actuator, in which the controller includes a processor and a memory. The controller is configured to identify potential contact between at least one tine coupled to a bat tube and the cutter bar assembly, and the controller is configured to determine whether a distance between the diverter and a follower coupled to the bat tube along a path of the follower is greater than a threshold distance. The controller is also configured to control the actuator to drive the diverter to the engaged position in response to identifying the potential contact between the tine(s) and the cutter bar assembly and determining the distance between the diverter and the follower is greater than the threshold distance. Because the controller does not control the actuator to drive the diverter to the engaged position while the follower is less than or equal to the threshold distance from the diverter, the possibility of the follower engaging the diverter while the diverter is in an intermediate position between the engaged and disengaged positions is substantially reduced or eliminated.

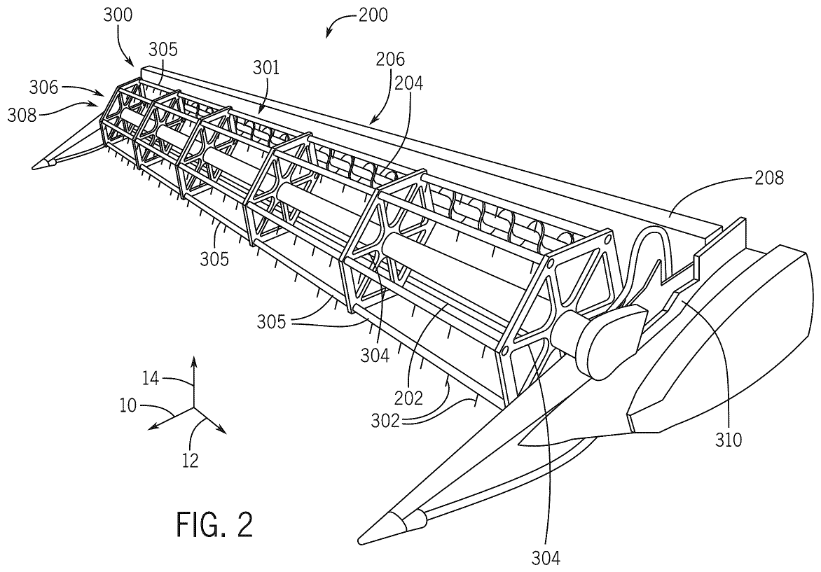

FIG. 2 is a perspective view of an embodiment of a header 200 that may be employed within the agricultural harvester of FIG. 1. In the illustrated embodiment, the header 200 includes a cutter bar assembly 202 configured to cut a portion of each crop (e.g., a stalk), thereby separating the crop from the soil. The cutter bar assembly 202 is positioned at a forward end of the header 200 relative to a longitudinal axis 10 of the header 200. As illustrated, the cutter bar assembly 202 extends along a substantial portion of the width of the header 200 (e.g., the extent of the header 200 along a lateral axis 12). The cutter bar assembly includes a blade support, a stationary guard assembly, and a moving blade assembly. The moving blade assembly is fixed to the blade support (e.g., above the blade support with respect to a vertical axis 14 of the header 200), and the blade support/moving blade assembly is driven to oscillate relative to the stationary guard assembly. In certain embodiments, the blade support/moving blade assembly is driven to oscillate by a driving mechanism positioned at the lateral center of the header. However, in other embodiments, the blade support/moving blade assembly may be driven by another suitable mechanism (e.g., located at any suitable position on the header). As the harvester is driven through a field, the cutter bar assembly 202 engages crops within the field, and the moving blade assembly cuts the crops (e.g., the stalks of the crops) in response to engagement of the cutter bar assembly 202 with the crops.

In the illustrated embodiment, the header 200 includes an auger 204 configured to rotate. The auger 204 may be driven to rotate by any suitable drive mechanism, such as an electric motor or a hydraulic motor. The auger 204 includes flighting configured to engage the cut crops and to drive the cut crops laterally inwardly as the auger 204 rotates.

In the illustrated embodiment, the crops cut by the cutter bar assembly 202 are directed toward the auger 204 by a reel assembly 300 (e.g., agricultural harvester reel assembly), thereby substantially reducing the possibility of the cut crops falling onto the surface of the field. The reel assembly 300 includes a reel 301 having multiple tines 302, and the reel 301 includes a rotating structure 304 that is driven to rotate (e.g., by one or more electric motors, by one or more hydraulic motors, etc.). Furthermore, the reel 301 includes multiple bat tubes 305 rotatably coupled to the rotating structure 304, and a respective set of tines 302 is coupled to each bat tube 305. The reel assembly 300 includes a tine rotation mechanism 306 (e.g., cam and follower assembly or parallel state assembly). The tine rotation mechanism 306 is configured to drive the bat tubes 305 to rotate relative to the rotating structure 304 (e.g., in response to rotation of the rotating structure 304). Accordingly, the tines 302 rotate in a first pattern (e.g., circular pattern) about the rotational axis of the rotating structure 304 and in second patterns (e.g., circular patterns or oscillating patterns) about the rotational axes of respective bat tubes 305. The tines are configured to engage the cut crops and to urge the cut crops to move toward the auger. In response to engagement with the flighting of the auger 204, the cut crops are driven inwardly, thereby enabling the cut crops to move through an opening 206 in the header 200 to the inlet of the agricultural crop processing system.

In the illustrated embodiment, the cutter bar assembly 202 is flexible along the width of the header 200 (e.g., the extent of the header 200 along the lateral axis 12). The cutter bar assembly 202 is supported by multiple arm assemblies distributed along the width of the header 200 (e.g., along the lateral axis 12 of the header 200). Each arm assembly is mounted to a frame 208 of the header 200 and includes an arm configured to rotate about the lateral axis 12 and/or move along the vertical axis 14 relative to the frame. Each rotatable/movable arm is coupled to the cutter bar assembly 202, thereby enabling the cutter bar assembly 202 to flex during operation of the harvester. The flexible cutter bar assembly may follow the contours of the field, thereby enabling the cutting height (e.g., the height at which each crop is cut) to be substantially constant along the width of the header 200 (e.g., the extent of the header 200 along the lateral axis 12). While the cutter bar assembly 202 is flexible in the illustrated embodiment, in other embodiments, the cutter bar assembly may be rigid.

In the illustrated embodiment, the reel 301 is supported by a first arm 308 coupled to the frame 208 and by a second arm 310 coupled to the frame 208. In certain embodiments, an actuator is coupled to each arm and configured to drive the arm to rotate about the lateral axis 12, thereby controlling a position of the reel 301 relative to the frame 208 along the vertical axis 14 (e.g., to control engagement of the tines with the cut crops). While the reel 301 is supported by two arms in the illustrated embodiment, in other embodiments, the reel may be supported by more or fewer arms.

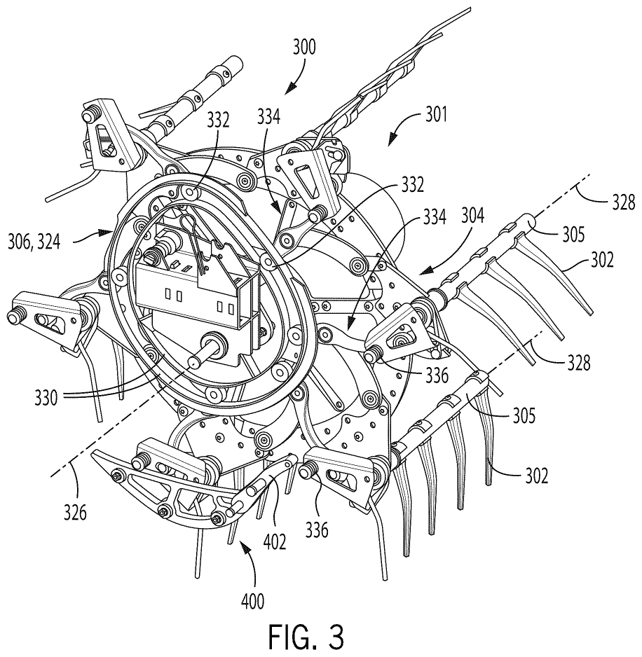

FIG. 3 is a perspective view of a portion of an embodiment of a reel assembly 300 that may be employed within the header of FIG. 2, in which the reel assembly 300 includes a diverter system 400. As previously discussed, the reel assembly 300 includes a reel 301 having multiple tines 302, and the reel 301 includes a rotating structure 304 that is driven to rotate (e.g., by one or more electric motors, by one or more hydraulic motors, etc.). Furthermore, the reel 301 includes multiple bat tubes 305 rotatably coupled to the rotating structure 304, and a respective set of tines 302 is coupled to each bat tube 305. The reel assembly 300 also includes a tine rotation mechanism 306.

In the illustrated embodiment, each tine rotation mechanism 306 includes a cam and follower assembly 324. The cam and follower assembly 324 is configured to drive the bat tubes 305 to rotate relative to the rotating structure 304 in response to rotation of the rotating structure 304. Accordingly, the tines 302 rotate in a first pattern (e.g., circular pattern) about the rotational axis 326 of the rotating structure 304 and in second patterns (e.g., circular patterns or oscillating patterns) about the rotational axes 328 of respective bat tubes 305. In the illustrated embodiment, the cam and follower assembly 324 includes a cam track 330 and cam track followers 332 engaged with the cam track 330. Each cam track follower 332 is coupled to a respective bat tube 305 by a respective linkage assembly 334. As the rotating structure 304 rotates about the rotational axis 326, the cam track followers 332 are driven to move around the cam track 330. Due to the shape of the cam track 330, as each cam track follower 332 moves around the cam track 330, the respective linkage assembly 334 drives the respective bat tube 305 to rotate, thereby driving the tines 302 coupled to the respective bat tube 305 to rotate in the second pattern about the respective bat tube rotational axis 328.

As discussed in detail below, the diverter system 400 includes a diverter 402 configured to move between an engaged position and a disengaged position. The diverter 402 is configured to engage followers 336 of the reel assembly 300 while the diverter is in the engaged position, and each follower 336 of the reel assembly 300 is coupled to a respective bat tube 305. While the diverter 402 is in the engaged position, engagement of a follower 336 with the diverter 402 drives the respective bat tube 305 to rotate, thereby driving the tines 302 coupled to the bat tube 305 to move to a retracted position. While the tines 302 are in the retracted position, the possibility of the tines contacting the cutter bar assembly is substantially reduced or eliminated. The diverter system 400 also includes an actuator configured to drive the diverter to move from the disengaged position to the engaged position. In addition, the diverter system 400 includes a diverter control system having a controller communicatively coupled to the actuator, in which the controller includes a processor and a memory. The controller is configured to identify potential contact between at least one tine coupled to a bat tube and the cutter bar assembly, and the controller is configured to determine whether a distance between the diverter and a follower coupled to the bat tube along a path of the follower is greater than a threshold distance. The controller is also configured to control the actuator to drive the diverter to the engaged position in response to identifying the potential contact between the tine(s) and the cutter bar assembly and determining the distance between the diverter and the follower is greater than the threshold distance. Because the controller does not control the actuator to drive the diverter to the engaged position while the follower is less than or equal to the threshold distance from the diverter, the possibility of the follower engaging the diverter while the diverter is in an intermediate position between the engaged and disengaged positions is substantially reduced or eliminated.

While the diverter system is disclosed herein with regard to a reel assembly that includes a tine rotation mechanism having a cam and follower assembly, in certain embodiments, the diverter system may be employed within a reel assembly that includes a tine rotation mechanism having a parallel state assembly. The parallel state assembly includes an adjustment wheel configured to drive the bat tubes to rotate relative to the rotating structure. In addition, the rotating structure includes a main wheel configured to rotate about the rotational axis of the rotating structure, and the adjustment wheel is configured to rotate about a second rotational axis, which is offset from the rotational axis of the rotating structure. Furthermore, the parallel state assembly includes links, in which each link is non-rotatably coupled to a respective bat tube and rotatably coupled to the adjustment wheel. Because the links are non-rotatably coupled to the bat tubes and the bat tubes are rotatably coupled to the main wheel, rotation of the rotating structure drives the links to rotate in the first circular pattern about the rotational axis of the rotating structure. Furthermore, because the links are rotatably coupled to the adjustment wheel, rotation of the links in the first circular pattern about the rotational axis of the rotating structure drives the adjustment wheel to rotate about the second rotational axis of the adjustment wheel. Due to the offset between the rotational axis of the rotating structure and the second rotational axis of the adjustment wheel, rotation of the adjustment wheel and the main wheel drives the links to rotate relative to the adjustment wheel. In addition, due to the non-rotatable coupling between the links and the respective bat tubes, rotation of the links drives the respective bat tubes to rotate. As a result, the tines rotate in the second circular pattern about the respective bat tube rotational axes.

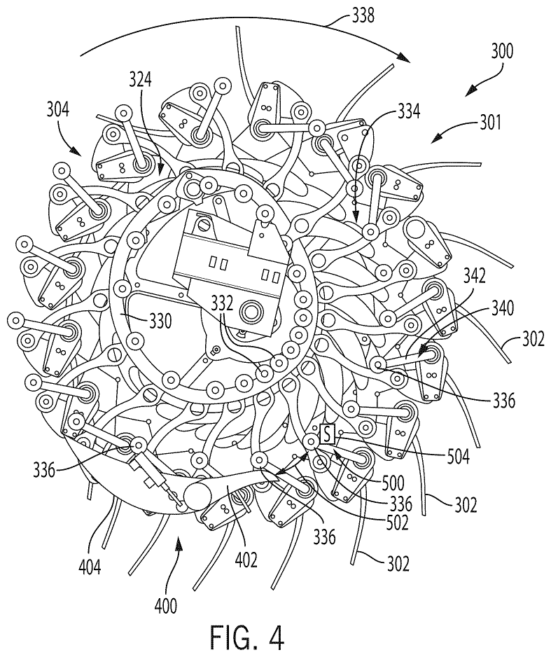

FIG. 4 is a side view of the reel assembly 300 of FIG. 3, in which the diverter 402 of the diverter system 400 is in the disengaged position. As previously discussed, the cam and follower assembly 324 is configured to drive the bat tubes to rotate relative to the rotating structure 304 in response to rotation of the rotating structure 304. Accordingly, the tines 302 rotate in the first pattern (e.g., circular pattern) about the rotational axis of the rotating structure and in second patterns (e.g., circular patterns or oscillating patterns) about the rotational axes of respective bat tubes. As the rotating structure 304 rotates about the rotational axis of the rotating structure in a direction of rotation 338, the cam track followers 332 are driven to move around the cam track 330. Due to the shape of the cam track 330, as each cam track follower 332 moves around the cam track 330, the respective linkage assembly 334 drives the respective bat tube to rotate, thereby driving the tines 302 coupled to the respective bat tube to rotate in the second pattern about the respective bat tube rotational axis.

Furthermore, as previously discussed, the diverter 402 of the diverter system 400 is configured to move between an engaged position and a disengaged position. The diverter 402 is configured to engage followers 336 of the reel assembly 300 while the diverter is in the engaged position, and engagement of a follower 336 with the diverter 402 drives the respective bat tube to rotate, thereby driving the tines 302 coupled to the bat tube to move to the retracted position. In the illustrated embodiment, the diverter system 400 also includes a cam surface 404 extending in the direction of rotation 338 from a trailing end of the diverter 402. The diverter 402 is configured to direct each follower 336 to engage the cam surface 404 while the diverter 402 is in the engaged position, and engagement of the follower 336 with the cam surface 404 maintains the respective tines 302 in the retracted position. As previously discussed, while the tines 302 are in the retracted position, the possibility of the tines contacting the cutter bar assembly is substantially reduced or eliminated.

In the illustrated embodiment, each follower 336 is coupled to the respective bat tube by a respective latch assembly 340. The latch assembly 340 includes a follower bracket 342, and the follower 336 is coupled to the follower bracket 342. As discussed in detail below, the latch assembly 340 is configured to non-rotatably couple the respective bat tube to a rocker arm of the respective linkage assembly 334 while the respective follower 336 is not engaged with the diverter 402 or the cam surface 404. Accordingly, the linkage assembly 334 drives the respective bat tube to rotate as the respective cam track follower 332 moves around the cam track 330, thereby driving the tines 302 coupled to the respective bat tube to rotate in the second pattern about the respective bat tube rotational axis. In addition, the latch assembly 340 is configured to enable rotation of the bat tube relative to the rocker arm of the linkage assembly 334 in response to engagement of the follower 336 with the diverter 402 or the cam surface 404. In addition, engagement of the follower 336 with the diverter 402 drives the follower bracket 342 to rotate relative to the rocker arm of the linkage assembly 334, and rotation of the follower bracket 342 relative to the rocker arm drives a bat tube bracket, which is coupled to the bat tube, to rotate. Accordingly, engagement of the follower 336 with the diverter 402 drives the respective bat tube to rotate, thereby driving the tines 302 coupled to the bat tube to move to the retracted position.

As illustrated, the diverter 402 of the diverter system 400 is in the disengaged position. Accordingly, each follower 336 does not engage the diverter 402 as the rotating structure 304 rotates in the direction of rotation 338. As such, the respective latch assembly 340 non-rotatably couples the respective bat tube to the rocker arm of the respective linkage assembly 334, thereby enabling the respective linkage assembly 334 to drive the respective bat tube to rotate as the respective cam track follower 332 moves around the cam track 330. As a result, the tines 302 coupled to the respective bat tube rotate in the second pattern about the respective bat tube rotational axis.

As discussed in detail below, the diverter system 400 includes an actuator configured to drive the diverter 402 to move from the illustrated disengaged position to the engaged position. In addition, the diverter system includes a diverter control system 500 having a controller. The controller is communicatively coupled to the actuator, and the controller includes a processor and a memory. The controller is configured to identify potential contact between at least one tine 302 coupled to one bat tube and the cutter bar assembly, and the controller is configured to determine whether a distance 502 between the diverter 402 and the follower coupled to the bat tube is greater than a threshold distance. As used herein, the distance 502 between the diverter 402 and the follower 336 is the distance between the diverter and the follower along the path of the follower. In addition, the controller is configured to control the actuator to drive the diverter to the engaged position in response to identifying the potential contact between the tine(s) 302 and the cutter bar assembly and determining the distance 502 between the diverter 402 and the respective follower 336 is greater than the threshold distance. Because the controller does not control the actuator to drive the diverter 402 to the engaged position while the respective follower 336 is less than or equal to the threshold distance from the diverter 402, the possibility of the respective follower 336 engaging the diverter 402 while the diverter 402 is in an intermediate position between the engaged and disengaged positions is substantially reduced or eliminated.

For example, the reel may be positioned such that the tines are proximate to the cutter bar assembly. During operation of the agricultural harvester, the cutter bar assembly may flex due to variations in the terrain. Accordingly, the controller may identify potential contact between at least one of the tines (e.g., at least one of the tines coupled to the bat tube approaching a location that positions the tines closest to the cutter bar assembly) and the cutter bar assembly, and the controller may control the actuator to drive the diverter to the engaged position, which causes the tines (e.g., the tines coupled to the bat tube approaching the location that positions the tines closest to the cutter bar assembly) to move to the retracted position, thereby substantially reducing or eliminating the possibility of the tines contacting the cutter bar assembly.

However, in response to determining that the distance 502 between the diverter 402 and the respective follower 336 along the path of the respective follower 336 is less than or equal to the threshold distance, the controller does not control the actuator to drive the diverter to the engaged position. Instead, in certain embodiments, the controller may delay controlling the actuator until the respective follower 336 reaches the diverter 402. Once the respective follower 336 reaches the diverter 402, the controller may determine whether a distance between the diverter 402 and a subsequent follower 336 along the path of the subsequent follower 336 is greater than the threshold distance. In response to identifying the potential contact between at least one of the tines coupled to the subsequent bat tube and the cutter bar assembly and determining the distance between the diverter and the subsequent follower is greater than the threshold distance, the controller may control the actuator to drive the diverter 402 to the engaged position. In certain embodiments, with regard to determining the distance between the diverter and a follower along the path of the follower, the follower may be the closest follower to the diverter along the path of the follower that has not reached or past the diverter as the follower moves in the direction of rotation of the rotating structure.

In certain embodiments, the controller is configured to determine the threshold distance based on the rotational speed of the rotating structure 304 and a duration sufficient for the actuator to drive the diverter 402 from the disengaged position to the engaged position. For example, the controller may determine the threshold distance to be equal to the time sufficient for the actuator to drive the diverter from the disengaged position to the engaged position multiplied by the speed of the follower along the path of the follower, which may be determined based on the rotational speed of the rotating structure 304 because the followers are coupled to the rotating structure. Accordingly, if the distance between the diverter and the follower along the path of the follower is greater than the threshold distance, the diverter may move to the engaged position before the follower engages the diverter, thereby substantially reducing or eliminating the possibility of the follower engaging the diverter while the diverter is in an intermediate position between the engaged and disengaged positions.

Furthermore, in certain embodiments, the controller is configured to determine the threshold distance based on the rotational speed of the rotating structure 304, the rotational acceleration of the rotating structure 304, and the duration sufficient for the actuator to drive the diverter 402 from the disengaged position to the engaged position. For example, the controller may determine the threshold distance to be equal to the time sufficient for the actuator to drive the diverter from the disengaged position to the engaged position multiplied by the speed of the follower along the path of the follower and added to the square of the time sufficient for the actuator to drive the diverter from the disengaged position to the engaged position multiplied by the acceleration of the follower along the path of the follower. As previously discussed, the speed of the follower along the path of the follower may be determined based on the rotational speed of the rotating structure 304 because the followers are coupled to the rotating structure. In addition, the acceleration of the follower along the path of the follower may be determined based on the rotational acceleration of the rotating structure 304 because the followers are coupled to the rotating structure. Accordingly, if the distance between the diverter and the follower along the path of the follower is greater than the threshold distance, the diverter may move to the engaged position before the follower engages the diverter, thereby substantially reducing or eliminating the possibility of the follower engaging the diverter while the diverter is in an intermediate position between the engaged and disengaged positions.

In the illustrated embodiment, the diverter control system 500 includes a proximity sensor 504 communicatively coupled to the controller. The proximity sensor is configured to output a sensor signal indicative of presence of a follower at the proximity sensor. The controller is configured to receive the sensor signal from the proximity sensor, and the controller is configured to determine the distance between the diverter 402 and the follower 336 along the path of the follower 336 based on the presence of the follower at the proximity sensor. For example, if the proximity sensor is positioned at a certain distance from the diverter along the path of the follower, the controller may determine the follower is at the certain distance based on the presence of the follower at the proximity sensor. In certain embodiments, the controller may also receive a signal indicative of the rotational speed of the rotating structure. In such embodiments, the controller may determine the position of the follower based on the time since the follower was present at the proximity sensor and the speed of the follower along the path of the follower, which may be determined based on the rotational speed of the rotating structure. Furthermore, in certain embodiments, the controller may receive a signal indicative of the rotational speed of the rotating structure and a signal indicative of the rotational acceleration of the rotating structure. In such embodiments, the controller may determine the position of the follower based on the time since the follower was present at the proximity sensor, the speed of the follower along the path of the follower, which may be determined based on the rotational speed of the rotating structure, and the acceleration of the follower along the path of the follower, which may be determined based on the rotational acceleration of the rotating structure.

Furthermore, in certain embodiments, the controller may determine the rotational speed of the rotating structure based on a frequency of the presence of each follower at the proximity sensor. For example, the rotational speed in degrees per second may be equal to 360 degrees divided by the time sufficient for one rotation of the rotating structure, and the time sufficient for one rotation of the rotating structure may be equal to the number of followers divided by the frequency. As previously discussed, the controller may determine the threshold distance based on the rotational speed of the rotating structure (e.g., as determined based on feedback from the proximity sensor) and the duration sufficient for the actuator to drive the diverter from the disengaged position to the engaged position. In addition, in certain embodiments, the controller may determine the rotational acceleration of the rotating structure based on a change in the frequency of the presence of each follower at the proximity sensor. As previously discussed, the controller may determine the threshold distance based on the rotational speed of the rotating structure (e.g., as determined based on feedback from the proximity sensor), the rotational acceleration of the rotating structure (e.g., as determined based on feedback from the proximity sensor), and the duration sufficient for the actuator to drive the diverter from the disengaged position to the engaged position.

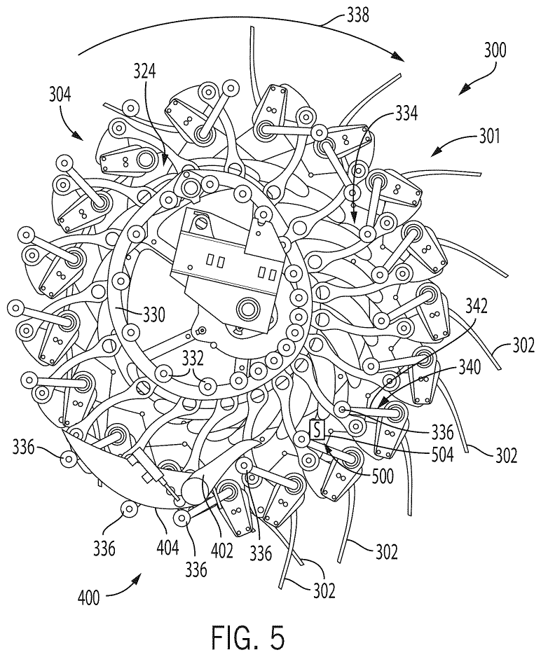

FIG. 5 is a side view of the reel assembly 300 of FIG. 3, in which the diverter 402 of the diverter system 400 is in the engaged position. With the diverter 402 in the engaged position, each follower 336 engages the diverter 402 as the rotating structure 304 rotates in the direction of rotation 338, and the diverter 402 directs the follower 336 to the cam surface 404. In response to engagement of the follower 336 with the diverter 402, the latch assembly 340 enables rotation of the bat tube relative to the rocker arm of the linkage assembly 334. In addition, engagement of the follower 336 with the diverter 402 drives the follower bracket 342 to rotate relative to the rocker arm of the linkage assembly 334, and rotation of the follower bracket 342 relative to the rocker arm drives the bat tube bracket to rotate. Accordingly, engagement of the follower 336 with the diverter 402 drives the respective bat tube to rotate, thereby driving the tines 302 coupled to the bat tube to move to the retracted position, as illustrated. In addition, engagement of the follower 336 with the cam surface 404 maintains the orientation of the bat tube relative to the rocker arm, thereby maintaining the respective tines 302 in the retracted position. As previously discussed, while the tines 302 are in the retracted position, the possibility of the tines contacting the cutter bar assembly is substantially reduced or eliminated.

While the diverter 402 is in the engaged position, the controller may continue to identify the potential contact between the tine(s) and the cutter bar assembly. In response to determining the potential contact has terminated (e.g., the cutter bar assembly has moved away from the reel), the controller may control a return actuator to drive the diverter 402 from the illustrated engaged position to the disengaged position. As previously discussed, with the diverter in the disengaged position, each follower 336 does not engage the diverter 402 as the rotating structure 304 rotates in the direction of rotation 338. As such, the respective latch assembly 340 non-rotatably couples the respective bat tube to the rocker arm of the respective linkage assembly 334, thereby enabling the respective linkage assembly 334 to drive the respective bat tube to rotate as the respective cam track follower 332 moves around the cam track 330. As a result, the tines 302 coupled to the respective bat tube rotate in the second pattern about the respective bat tube rotational axis.

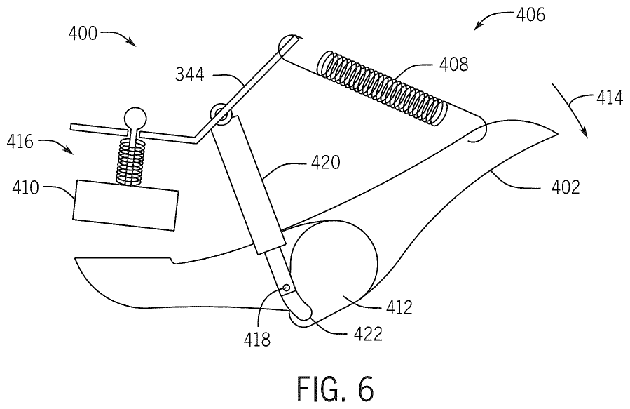

FIG. 6 is a side view of an embodiment of a diverter system 400 that may be employed within the reel assembly of FIG. 3. As previously discussed, the diverter 402 of the diverter system 400 is configured to move between the illustrated engaged position and the disengaged position. The diverter 402 is configured to engage a follower to drive the respective tines to the retracted position while the diverter is in the illustrated engaged position. In addition, the diverter system 400 includes an actuator 406 configured to drive the diverter to move from the disengaged position to the illustrated engaged position.

In the illustrated embodiment, the actuator 406 includes a spring 408 configured to urge the diverter 402 toward the engaged position. In addition, the actuator 406 includes an electromagnet 410 configured to selectively hold the diverter 402 in the disengaged position. In the illustrated embodiment, the diverter 402 is pivotally coupled to a support structure 344 of the reel assembly 300 by a pivot joint 412. The support structure 344 is non-movably coupled to the frame of the header, such that the diverter 402 does not rotate with the reel. Furthermore, the spring 408 is configured to urge the diverter 402 to rotate toward the illustrated engaged position. For example, the spring 408 may be a tension spring, in which the spring force increases as the diverter 402 rotates from the illustrated engaged position to the disengaged position, thereby urging the diverter 402 toward the illustrated engaged position. In the illustrated embodiment, the spring 408 is coupled to the diverter 402 and to the support structure 344. In addition, the electromagnet 410 is coupled to the support structure 344 by a cushion assembly 416.

While the diverter 402 is in the disengaged position, the electromagnet 410 is activated, and the diverter 402 is engaged with the electromagnet 410. The electromagnet 410 holds the diverter 402 in the disengaged position against the force applied by the spring 408. Furthermore, the controller is communicatively coupled to the electromagnet 410 of the actuator 406, and the controller is configured to control the actuator 406 to drive the diverter to the engaged position by deactivating the electromagnet 410. With the electromagnet 410 deactivated, the spring 408 drives the diverter 402 from the disengaged position to the illustrated engaged position. In the illustrated embodiment, further rotation of the diverter 402 beyond the engaged position is blocked by contact between a pin 418 of a return actuator 420 and the diverter 402. As illustrated, the pin 418 of the return actuator 420 is disposed within a slot 422 of the diverter 402, and contact between the pin 418 and the material of the diverter 402 at the end of the slot 422 blocks rotation of the diverter 402 beyond the engaged position as the diverter rotates between the disengaged position and the engaged position. In the illustrated embodiment, the return actuator 420 includes a hydraulic cylinder. However, in other embodiments, the return actuator may include any other suitable type of linear actuator, such as an electric linear actuator or a pneumatic cylinder.

The return actuator 420 is configured to drive the diverter 402 from the illustrated engaged position to the disengaged position. The controller is communicatively coupled to the return actuator 420, and the controller is configured to control the return actuator to retract, thereby driving the diverter 402 from the illustrated engaged position to the disengaged position. As the return actuator 420 retracts, contact between the pin 418 and the material at the end of the slot 422 drives the diverter 402 to rotate, such that the diverter 402 contacts the electromagnet 410. The cushion assembly 416 enables the return actuator 420 to drive the diverter 402 beyond the point of contact with the electromagnet 410. For example, the return actuator 420 may drive the diverter 402 to rotate until the return actuator 420 is fully retracted. Once the diverter 402 is in contact with the electromagnet 410, the controller may activate the electromagnet 410 to couple the electromagnet 410 to the diverter 402. Once the electromagnet 410 is activated, the return actuator 402 may extend, such that the pin 418 moves away from the end of the slot, which enables the diverter 402 to rotate from the disengaged position to the engaged position. With the electromagnet activated and the pin 418 positioned away from the end of the slot, the diverter 402 is in the disengaged position.

While the actuator 406 includes the spring 408 and the electromagnet 410 in the illustrated embodiment, in other embodiments, the actuator may include any other suitable type(s) of actuation device(s) configured to drive the diverter from the disengaged position to the engaged position. Furthermore, while the diverter system 400 includes the actuator 406 and the return actuator 420 in the illustrated embodiment, in other embodiments, the diverter system may include a single actuator configured to drive the diverter from the engaged position to the disengaged position and from the disengaged position to the engaged position. For example, the diverter system may include a single spring loaded solenoid.

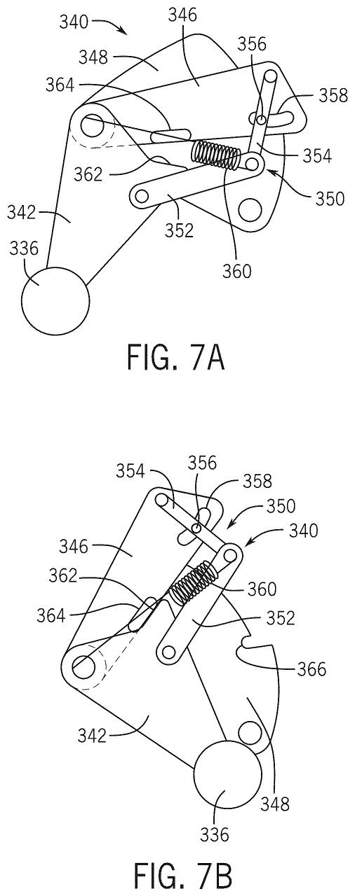

FIG. 7A is a side view of an embodiment of a latch assembly 340 that may be employed within the reel assembly of FIG. 3, in which the latch assembly 340 is in a latched state. As previously discussed, the latch assembly 340 couples the follower 336 to the respective bat tube. In the illustrated embodiment, the latch assembly 340 includes a follower bracket 342, and the follower 336 is coupled to the follower bracket 342. In addition, the latch assembly 340 includes a bat tube bracket 346 non-rotatably coupled to the bat tube, and the follower bracket 342 and the bat tube bracket 346 are pivotally coupled to the rocker arm 348 of the respective linkage assembly. The latch assembly 340 also includes a locking mechanism 350 configured to selectively non-rotatably couple the bat tube bracket 346 to the rocker arm 348, thereby non-rotatably coupling the bat tube to the rocker arm 348. Accordingly, with the locking mechanism 350 engaged, the bat tube is non-rotatably coupled to the rocker arm 348 of the linkage assembly. As a result, the linkage assembly drives the bat tube to rotate as the respective cam track follower moves around the cam track, thereby driving the tines coupled to the bat tube to rotate in the second pattern about the bat tube rotational axis.

In the illustrated embodiment, the locking mechanism 350 includes a first link 352 pivotally coupled to the follower bracket 342, and the locking mechanism 350 includes a second link 354 pivotally coupled to the bat tube bracket 346. The first and second links are pivotally coupled to one another. In addition, the locking mechanism 350 includes a pin 356 coupled to the second link 354 and engaged with a slot 358 within the bat tube bracket 346. The pin 356 is also configured to engage a slot within the rocker arm 348 while the locking mechanism 350 is engaged. Engagement of the pin 356 with the slot within the rocker arm 348 non-pivotally couples the bat tube bracket 346 to the rocker arm 348. In addition, the locking mechanism 350 includes a spring 360 coupled to the first link 352 and configured to urge the pin 356 into engagement with the slot within the rocker arm 348, thereby non-pivotally coupling the bat tube bracket 346 to the rocker arm 348.

In response to engagement of the follower 336 with the diverter, the follower bracket 342 is driven to rotate relative to the rocker arm 348, thereby driving the pin 356 to disengaged the slot within the rocker arm 348 (e.g., against the force applied by the spring 360), such that the locking mechanism 350 is disengaged. As a result, rotation of the bat tube bracket 346 relative to the rocker arm 348 is enabled, thereby enabling the bat tube to rotate relative to the rocker arm 348. In addition, as the follower bracket 342 rotates relative to the rocker arm 348, an engagement surface 362 of the follower bracket 342 contacts a stop 364 of the bat tube bracket 346. Further rotation of the follower bracket 342 due to engagement of the follower 336 with the diverter causes the follower bracket 342 to drive the bat tube bracket 346 to rotate relative to the rocker arm 348, thereby driving the bat tube to rotate relative to the rocker arm 348. Accordingly, engagement of the follower 336 with the diverter drives the bat tube to rotate, thereby driving the tines coupled to the bat tube to move to the retracted position.

FIG. 7B is a side view of the latch assembly 340 of FIG. 7A, in which the latch assembly 340 is in an unlatched state. As illustrated, the pin 356 is disengaged from the slot 366 within the rocker arm 348, such that the locking mechanism 350 is disengaged. As a result, rotation of the bat tube bracket 346 relative to the rocker arm 348 is enabled, thereby enabling the bat tube to rotate relative to the rocker arm 348. In addition, due to the rotation of the follower bracket 342 relative to the rocker arm 348, the engagement surface 362 of the follower bracket 342 is in contact with the stop 364 of the bat tube bracket 346, and the bat tube bracket 346 is rotated relative to the rocker arm 348 (e.g., as compared to the orientation in FIG. 7A). Accordingly, the bat tube is oriented to position the tines coupled to the bat tube in the retracted position. Once the follower 336 disengages the cam surface, the follower bracket 342 returns to the orientation in FIG. 7A, and the spring 360 drives the pin 356 to reengage the slot 366 within the rocker arm 348, thereby transitioning the latch assembly 340 to the latched state.

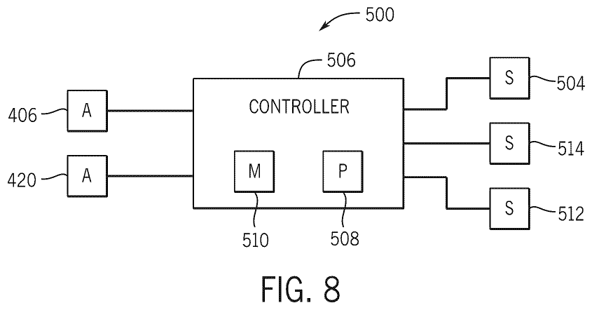

FIG. 8 is a block diagram of an embodiment of a diverter control system 500 that may be employed within the diverter system of FIG. 3. As previously discussed, the diverter control system 500 includes the proximity sensor 504 configured to output a sensor signal indicative of presence of a follower at the proximity sensor 504. The proximity sensor 504 may include any suitable type(s) of proximity sensing device(s), such as a capacitive sensor, an infrared sensor, a magnetic sensor, an ultrasonic sensor, a millimeter wave sensor, an inductive sensor, an optical sensor, other suitable type(s) of sensing device(s), or a combination thereof. In addition, as previously discussed, the diverter system includes the actuator 406 configured to drive the diverter to move from the disengaged position to the engaged position. In certain embodiments, the actuator 406 includes an electromagnet configured to selectively hold the diverter in the disengaged position, and a spring configured to urge the diverter to the engaged position. Furthermore, as previously discussed, the diverter system includes the return actuator 420 configured to drive the diverter to move from the engaged position to the disengaged position. The return actuator 420 may include a hydraulic cylinder or another suitable type of actuation device, such as an electric linear actuator or a pneumatic cylinder.

In the illustrated embodiment, the diverter control system 500 includes a controller 506 communicatively coupled to the proximity sensor 504, to the actuator 406, and to the return actuator 420. In certain embodiments, the controller 506 is an electronic controller having electrical circuitry configured to control the actuator 406 and the return actuator 420. In the illustrated embodiment, the controller 506 includes a processor 508, such as a microprocessor, and a memory device 510. The controller 506 may also include one or more storage devices and/or other suitable components. The processor 508 may be used to execute software, such as software for controlling the actuator 406 and the return actuator 420, and so forth. Moreover, the processor 508 may include multiple microprocessors, one or more “general-purpose” microprocessors, one or more special-purpose microprocessors, one or more application specific integrated circuits (ASICS), and/or one or more field-programmable gate arrays (FPGA), or some combination thereof. For example, the processor 508 may include one or more reduced instruction set (RISC) processors.

The memory device 510 may include a volatile memory, such as random access memory (RAM), and/or a nonvolatile memory, such as read-only memory (ROM). The memory device 510 may store a variety of information and may be used for various purposes. For example, the memory device 510 may store processor-executable instructions (e.g., firmware or software) for the processor 508 to execute, such as instructions for controlling the actuator 406 and the return actuator 420, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the actuator 406 and the return actuator 420, etc.), and any other suitable data.

The controller 506 is configured to identify potential contact between at least one tine coupled to a bat tube and the cutter bar assembly. In addition, the controller 506 is configured to determine whether a distance between the diverter and a follower coupled to the bat tube along a path of the follower is greater than a threshold distance. The controller 506 is also configured to control the actuator 406 (e.g., deactivate the electromagnet) to drive the diverter to the engaged position in response to identifying the potential contact between the tine(s) and the cutter bar assembly and determining the distance between the diverter and the follower is greater than the threshold distance. Because the controller 506 does not control the actuator 406 to drive the diverter to the engaged position while the follower is less than or equal to the threshold distance from the diverter, the possibility of the follower engaging the diverter while the diverter is in an intermediate position between the engaged and disengaged positions is substantially reduced or eliminated.

While the diverter 402 is in the engaged position, the controller 506 may continue to identify the potential contact between the tine(s) and the cutter bar assembly. In response to determining the potential contact has terminated (e.g., the cutter bar assembly has moved away from the reel), the controller 506 may control the return actuator 420 to drive the diverter 402 from the engaged position to the disengaged position. With the diverter in the disengaged position, subsequent followers do not engage the diverter as the rotating structure rotates. As such, the linkage assemblies drive the respective bat tubes to rotate as the respective cam track followers move around the cam track. As a result, the tines coupled to the respective bat tubes rotate in the second pattern about the respective bat tube rotational axes.

In certain embodiments, the controller 506 is configured to determine the distance between the diverter and the follower based on feedback from the proximity sensor 504. For example, the controller 506 may receive the sensor signal from the proximity sensor 504 indicative of presence of the follower at the proximity sensor, and the controller 506 may determine the distance between the diverter and the follower based on the presence of the follower at the proximity sensor 504. For example, if the proximity sensor 504 is positioned a certain distance from the diverter along the path of the follower, the controller 506 may determine the follower is at the certain distance based on the presence of the follower at the proximity sensor 504. In certain embodiments, the controller 506 may also receive a signal indicative of the rotational speed of the rotating structure (e.g., from a rotational speed sensor). In such embodiments, the controller 506 may determine the position of the follower based on the time since the follower was present at the proximity sensor and the speed of the follower along the path of the follower, which may be determined based on the rotational speed of the rotating structure. Furthermore, in certain embodiments, the controller 506 may receive a signal indicative of the rotational speed of the rotating structure (e.g., from a rotational speed sensor) and a signal indicative of the rotational acceleration of the rotating structure (e.g., from a rotational acceleration sensor). In such embodiments, the controller 506 may determine the position of the follower based on the time since the follower was present at the proximity sensor, the speed of the follower along the path of the follower, which may be determined based on the rotational speed of the rotating structure, and the acceleration of the follower along the path of the follower, which may be determined based on the rotational acceleration of the rotating structure.

Furthermore, in certain embodiments, the controller 506 may determine the rotational speed of the rotating structure based on a frequency of the presence of each follower at the proximity sensor 504. For example, the rotational speed in degrees per second may be equal to 360 degrees divided by the time sufficient for one rotation of the rotating structure, and the time sufficient for one rotation of the rotating structure may be equal to the number of followers divided by the frequency. As previously discussed, the controller 506 may determine the threshold distance based on the rotational speed of the rotating structure (e.g., as determined based on feedback from the proximity sensor) and the duration sufficient for the actuator to drive the diverter from the disengaged position to the engaged position. In addition, in certain embodiments, the controller 506 may determine the rotational acceleration of the rotating structure based on a change in the frequency of the presence of each follower at the proximity sensor. As previously discussed, the controller 506 may determine the threshold distance based on the rotational speed of the rotating structure (e.g., as determined based on feedback from the proximity sensor), the rotational acceleration of the rotating structure (e.g., as determined based on feedback from the proximity sensor), and the duration sufficient for the actuator to drive the diverter from the disengaged position to the engaged position.

In the illustrated embodiment, the diverter control system 500 includes a reel orientation sensor 512 communicatively coupled to the controller 506. The reel orientation sensor 512 is configured to output a sensor signal indicative of an orientation of the rotating structure of the reel assembly about the rotational axis of the rotating structure. In addition, the controller 506 is configured to receive the sensor signal from the reel orientation sensor 512, and the controller 506 is configured to determine the distance between the diverter and a follower based on the orientation of the rotating structure about the rotational axis of the rotating structure. For example, the circumferential position of each follower on the rotating structure may be stored within the controller. The controller may determine the position of each follower relative to the diverter based on the orientation of the rotating structure about the rotational axis of the rotating structure and the circumferential position of the follower on the rotating structure. The controller may then determine the distance between the diverter and the follower along the path of the follower based on the position of the follower relative to the diverter.

Furthermore, in certain embodiments, the controller 506 may determine the rotational speed of the rotating structure based on a rate of change of the orientation of the rotating structure about the rotational axis of the rotating structure. For example, a change in orientation of the rotating structure over a period of time, as monitored by the reel orientation sensor 512, may be divided by the period of time to determine the rotational speed of the rotating structure. As previously discussed, the controller 506 may determine the threshold distance based on the rotational speed of the rotating structure (e.g., as determined based on feedback from the reel orientation sensor) and the duration sufficient for the actuator to drive the diverter from the disengaged position to the engaged position. In addition, in certain embodiments, the controller 506 may determine the rotational acceleration of the rotating structure based on a rate of change of the rotational speed of the rotating structure (e.g., as determined based on feedback from the reel orientation sensor). The controller 506 may determine the threshold distance based on the rotational speed of the rotating structure (e.g., as determined based on feedback from the reel orientation sensor), the rotational acceleration of the rotating structure (e.g., as determined based on a rate of change of the rotational speed of the rotating structure), and the duration sufficient for the actuator to drive the diverter from the disengaged position to the engaged position. While the diverter control system 500 includes the proximity sensor 504 and the reel orientation sensor 512 in the illustrated embodiment, in other embodiments, the diverter control system may include only one of the proximity sensor or the reel orientation sensor.

In the illustrated embodiment, the diverter control system 500 includes a cutter bar assembly position sensor 514 communicatively coupled to the controller 506. The cutter bar position sensor 514 is configured to output a sensor signal indicative of potential contact between at least one tine of the reel assembly and the cutter bar assembly. For example, in certain embodiments, the cutter bar position sensor may be coupled to the cutter bar assembly and configured to monitor the distance between the cutter bar assembly and the tines of the reel assembly. In such embodiments, the controller may identify potential contact between at least one of the tines and the cutter bar assembly in response to determining the distance between the cutter bar assembly and the at least one tine is less than a threshold distance. Furthermore, in certain embodiments, the cutter bar assembly position sensor 514 may be coupled to the frame of the header and directed toward the cutter bar assembly. In such embodiments, the cutter bar assembly position sensor 514 may monitor the position of the cutter bar assembly relative to the frame of the header, the controller may determine the distance between the cutter bar assembly and the tines of the reel assembly based on feedback from the cutter bar assembly position sensor 514 and the position of the reel relative to the frame of the header (e.g., which may be determined based on feedback from a reel position sensor), and the controller may identify potential contact between at least one of the tines and the cutter bar assembly in response to determining the distance between the cutter bar assembly and the at least one tine is less than a threshold distance. In certain embodiments, the cutter bar assembly position sensor 514 may include an optical sensor, a LiDAR sensor, a RADAR sensor, a millimeter wave sensor, an infrared sensor, other suitable sensing device(s), or a combination thereof.

While one diverter is disclosed above with regard to the reel, in certain embodiments, the reel may include multiple sections (e.g., in which each section is associated with a respective tine rotation mechanism), and the reel assembly may include multiple diverters (e.g., one diverter for each section of the reel). In such embodiments, the diverter control system may control the actuators configured to move the respective diverters. Furthermore, while the diverter control system is disclosed above with regard to the diverter system of FIGS. 3-6 and the latch assembly of FIGS. 4-5, 7A-7B, the diverter control system may be used with any other suitable type of diverter system and/or latch assembly. For example, the diverter control system may be used with the diverter system and/or the latch assembly disclosed within any of U.S. patent application Ser. No. 17/939,033, Ser. No. 17/901,065, Ser. No. 17/891,417, Ser. No. 18/287,995. Each of U.S. patent application Ser. No. 17/939,033, Ser. No. 17/901,065, Ser. No. 17/891,417, Ser. No. 18/287,995 is incorporated by reference in its entirety. In addition, the diverter control system disclosed herein may be used with a diverter system and/or a latch assembly of a parallel state assembly.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f). CLAIMS:

1. A diverter control system for a reel assembly of an agricultural harvester, comprising:
a controller comprising a memory and a processor, wherein the controller is configured to:
identify potential contact between a tine coupled to a bat tube of the reel assembly and a cutter bar assembly of the agricultural harvester;
determine whether a distance between a diverter of a diverter system and a follower coupled to the bat tube along a path of the follower is greater than a threshold distance; and
control an actuator of the diverter system to drive the diverter to an engaged position in response to identifying the potential contact between the tine and the cutter bar assembly and determining the distance between the diverter and the follower is greater than the threshold distance, wherein the diverter is configured to engage the follower to drive the tine to a retracted position while the diverter is in the engaged position.

2. The diverter control system of claim 1, comprising a reel orientation sensor communicatively coupled to the controller, wherein the reel orientation sensor is configured to output a sensor signal indicative of an orientation of a rotating structure of the reel assembly about a rotational axis of the rotating structure, and the controller is configured to:
receive the sensor signal from the reel orientation sensor; and
determine the distance between the diverter and the follower based on the orientation of the rotating structure about the rotational axis of the rotating structure.

3. The diverter control system of claim 1, comprising a proximity sensor communicatively coupled to the controller, wherein the proximity sensor is configured to output a sensor signal indicative of presence of the follower at the proximity sensor; and the controller is configured to:
receive the sensor signal from the proximity sensor; and
determine the distance between the diverter and the follower based on the presence of the follower at the proximity sensor.

4. The diverter control system of claim 1, wherein the controller is configured to determine the threshold distance based at least in part on a rotational speed of a rotating structure of the reel assembly about a rotational axis of the rotating structure and a duration sufficient for the actuator to drive the diverter from a disengaged position to the engaged position.

5. The diverter control system of claim 4, comprising a reel orientation sensor communicatively coupled to the controller, wherein the reel orientation sensor is configured to output a sensor signal indicative of an orientation of the rotating structure about the rotational axis of the rotating structure, and the controller is configured to:
receive the sensor signal from the reel orientation sensor;
determine the distance between the diverter and the follower based on the orientation of the rotating structure about the rotational axis of the rotating structure; and determine the rotational speed of the rotating structure based on a rate of change of the orientation of the rotating structure about the rotational axis of the rotating structure.

6. The diverter control system of claim 4, comprising a proximity sensor communicatively coupled to the controller, wherein the proximity sensor is configured to output a sensor signal indicative of presence of the follower at the proximity sensor, and the controller is configured to:
receive the sensor signal from the proximity sensor;
determine the distance between the diverter and the follower based on the presence of the follower at the proximity sensor; and
determine the rotational speed of the rotating structure based on a frequency of the presence of the follower at the proximity sensor.

7. A diverter system for a reel assembly of an agricultural harvester, comprising:
a diverter configured to move between an engaged position and a disengaged position, wherein the diverter is configured to engage a follower coupled to a bat tube of the reel assembly to drive a tine coupled to the bat tube to a retracted position while the diverter is in the engaged position;
an actuator configured to drive the diverter to move from the disengaged position to the engaged position; and
a diverter control system comprising a controller communicatively coupled to the actuator, wherein the controller comprises a processor and a memory, and the controller is configured to:
identify potential contact between the tine and a cutter bar assembly of the agricultural harvester;
determine whether a distance between the diverter and the follower along a path of the follower is greater than a threshold distance; and
control the actuator to drive the diverter to the engaged position in response to identifying the potential contact between the tine and the cutter bar assembly and determining the distance between the diverter and the follower is greater than the threshold distance.

8. The diverter system of claim 7, wherein the actuator comprises:
a spring configured to urge the diverter toward the engaged position; and
an electromagnet configured to selectively hold the diverter in the disengaged position.

9. The diverter system of claim 7, wherein the diverter control system comprises a reel orientation sensor communicatively coupled to the controller, the reel orientation sensor is configured to output a sensor signal indicative of an orientation of a rotating structure of the reel assembly about a rotational axis of the rotating structure, and the controller is configured to:
receive the sensor signal from the reel orientation sensor; and
determine the distance between the diverter and the follower based on the orientation of the rotating structure about the rotational axis of the rotating structure.

10. The diverter system of claim 7, wherein the diverter control system comprises a proximity sensor communicatively coupled to the controller, the proximity sensor is configured to output a sensor signal indicative of presence of the follower at the proximity sensor; and the controller is configured to:
receive the sensor signal from the proximity sensor; and
determine the distance between the diverter and the follower based on the presence of the follower at the proximity sensor.

11. The diverter system of claim 7, wherein the controller is configured to determine the threshold distance based at least in part on a rotational speed of a rotating structure of the reel assembly about a rotational axis of the rotating structure and a duration sufficient for the actuator to drive the diverter from the disengaged position to the engaged position.

12. The diverter system of claim 11, wherein the diverter control system comprises a reel orientation sensor communicatively coupled to the controller, the reel orientation sensor is configured to output a sensor signal indicative of an orientation of the rotating structure about the rotational axis of the rotating structure, and the controller is configured to:
receive the sensor signal from the reel orientation sensor;
determine the distance between the diverter and the follower based on the orientation of the rotating structure about the rotational axis of the rotating structure; and
determine the rotational speed of the rotating structure based on a rate of change of the orientation of the rotating structure about the rotational axis of the rotating structure.

13. The diverter system of claim 11, wherein the diverter control system comprises a proximity sensor communicatively coupled to the controller, the proximity sensor is configured to output a sensor signal indicative of presence of the follower at the proximity sensor, and the controller is configured to:
receive the sensor signal from the proximity sensor;
determine the distance between the diverter and the follower based on the presence of the follower at the proximity sensor; and
determine the rotational speed of the rotating structure based on a frequency of the presence of the follower at the proximity sensor.

14. A reel assembly of an agricultural harvester, comprising:
a rotating structure configured to be driven in rotation about a rotational axis of the rotating structure;
a bat tube rotatably coupled to the rotating structure;
a follower coupled to the bat tube;
a plurality of tines coupled to the bat tube;
a tine rotation mechanism configured to drive the bat tube to rotate in response to rotation of the rotating structure; and
a diverter system, comprising:
a diverter configured to move between an engaged position and a disengaged position, wherein the diverter is configured to engage the follower to drive the plurality of tines to a retracted position while the diverter is in the engaged position;
an actuator configured to drive the diverter to move from the disengaged position to the engaged position; and
a diverter control system comprising a controller communicatively coupled to the actuator, wherein the controller comprises a processor and a memory, and the controller is configured to:
identify potential contact between at least one tine of the plurality of tines and a cutter bar assembly of the agricultural harvester;
determine whether a distance between the diverter and the follower along a path of the follower is greater than a threshold distance; and
control the actuator to drive the diverter to the engaged position in response to identifying the potential contact between the at least one tine and the cutter bar assembly and determining the distance between the diverter and the follower is greater than the threshold distance.

15. The reel assembly of claim 14, wherein the actuator comprises:
a spring configured to urge the diverter toward the engaged position; and
an electromagnet configured to selectively hold the diverter in the disengaged position.

16. The reel assembly of claim 14, wherein the diverter control system comprises a reel orientation sensor communicatively coupled to the controller, the reel orientation sensor is configured to output a sensor signal indicative of an orientation of the rotating structure about the rotational axis of the rotating structure, and the controller is configured to:
receive the sensor signal from the reel orientation sensor; and
determine the distance between the diverter and the follower based on the orientation of the rotating structure about the rotational axis of the rotating structure.

17. The reel assembly of claim 14, wherein the diverter control system comprises a proximity sensor communicatively coupled to the controller, the proximity sensor is configured to output a sensor signal indicative of presence of the follower at the proximity sensor; and the controller is configured to:
receive the sensor signal from the proximity sensor; and
determine the distance between the diverter and the follower based on the presence of the follower at the proximity sensor.

18. The reel assembly of claim 14, wherein the controller is configured to determine the threshold distance based at least in part on a rotational speed of the rotating structure about the rotational axis of the rotating structure and a duration sufficient for the actuator to drive the diverter from the disengaged position to the engaged position.

19. The reel assembly of claim 18, wherein the diverter control system comprises a reel orientation sensor communicatively coupled to the controller, the reel orientation sensor is configured to output a sensor signal indicative of an orientation of the rotating structure about the rotational axis of the rotating structure, and the controller is configured to:
receive the sensor signal from the reel orientation sensor;
determine the distance between the diverter and the follower based on the orientation of the rotating structure about the rotational axis of the rotating structure; and
determine the rotational speed of the rotating structure based on a rate of change of the orientation of the rotating structure about the rotational axis of the rotating structure.

20. The reel assembly of claim 18, wherein the diverter control system comprises a proximity sensor communicatively coupled to the controller, the proximity sensor is configured to output a sensor signal indicative of presence of the follower at the proximity sensor, and the controller is configured to:
receive the sensor signal from the proximity sensor;
determine the distance between the diverter and the follower based on the presence of the follower at the proximity sensor; and
determine the rotational speed of the rotating structure based on a frequency of the presence of the follower at the proximity sensor.
